(19) United States
(12) Patent Application Publication
(10) Pub. No.: US 2026/0037646 A1
(43) Pub. Date: Feb. 5, 2026

(54) Method for Secure Access to Digital Data

(71) Applicant: MailSPEC LLC, Las Vegas, NV (US)

(72) Inventors: Jon Doyle, Nice (FR); Freddy Frouin, Parthenay (FR); Tanguy Godquin, Caen (FR); Chukri Soueidi, Paris (FR)

(21) Appl. No.: 19/357,364

(22) Filed: Oct. 14, 2025

Related U.S. Application Data
(63) Continuation-in-part of application No. 18/115,977, filed on Mar. 1, 2023.

(30) Foreign Application Priority Data
Mar. 3, 2022 (FR) FR 2201865

(51) Int. Cl. G06F 21/60; H04L 9/08; H04L 9/32

(52) U.S. Cl. CPC G06F 21/602; H04L 9/0863; H04L 9/3228; H04L 9/3231

(57) ABSTRACT

The invention relates to a method for secure access to digital data, said digital data being encrypted with a given user's public encryption key and stored on a server. The method comprises the following steps:
A. receiving at said server a request from said user to access said digital data;
B. transmitting, via said server, via a secure communication interface, a request to a secure user device to release a password stored on said user device;
C. obtaining said password via said secure communication interface, from said user device in response to a validated security test issued by said user device to a user; and
D. retrieving, via said server, the user's encrypted private key, said user's private key being encrypted with said password, and decrypting said user's encrypted private key with said password to obtain that user's private key, and decrypting said encrypted digital data with said user's private key, and presenting said digital data to said user.

Another method is provided for new users who do not yet have encryption keys, where the sender temporarily encrypts the digital data and, upon user enrollment, the server re-encrypts the data to the user's public encryption key before proceeding with the server-assisted decryption process.

### FIELD OF THE INVENTION

The technical field of the present invention relates to the field of access to digital data, and in particular, access to digital data being encrypted with an encryption key.

### PRIOR ART

Email encryption is difficult to achieve because it forces users of a system to exchange encryption keys and use passwords that can often be complex and/or compromised by cyber attacks or hacking. Indeed, a user password generally consists of eight simple characters that take from two to 21 days to decrypt, depending on the complexity of the password. Moreover, the more complicated the password, the more difficult it is for users to remember it. In addition, passwords and encryption keys are stored on a server that can be accessed by the system administrator or data centre personnel. There are open source systems using Pretty Good Privacy (PGP) encryption technology. However, due to their complexity, these are rarely used.

### SUMMARY OF THE INVENTION

The invention improves the situation by offering a method of secure access to digital data, with said digital data being encrypted with a given user's public encryption key and stored on a server, and said method comprising the following steps:
A. receiving at said server a request from said user to access said digital data;
B. sending, by said server via a secure communication interface, a request to a secure user device to release a password stored on said user device;
C. obtaining said password via said secure communication interface, from said user device in response to a validated security test issued by said user device to a user; and
D. retrieving, via said server, the said user's encrypted private key which is encrypted with said password, and decrypting said user's private key encrypted with said password to obtain said user's private key, and decrypting said encrypted digital data with said user's private key, and presenting said digital data to said user.

In one implementation, wherein step A consists of logging in, the method comprising a subsequent step of deleting said private key and password from a memory of said server when the session is considered to be finished.

In addition, the invention improves the situation by offering a method of secure access to digital data, with said digital data being encrypted with a given user's public encryption key and stored on a server, and said method comprising the following steps:
A. receiving at a secure user device via a secure communication interface a request to release a password stored on a user device, said request being sent in response to receiving at said server a request from said user to access said digital data;
B. sending, by said secure device, a security test to a user thereof, and in response to a validated security test, releasing by said secure user device said password to said secure communication interface for retrieval by said server, said password being used in decrypting an encrypted private key to obtain the private key of said user, and decrypting said encrypted digital data with said private key of said user, for presenting said digital data to said user.

In one implementation, said step of issuing a security test by said secure user device comprises comparing a biometric input with biometric data associated with the said user stored on said secure user device, wherein said validated security test consists of determining whether said biometric input satisfies a predefined similarity criterion with respect to said biometric data associated with said user.

In one implementation, the password is stored in a secure chip of said secure user device.

In one implementation, said secure communication interface implements an SSL/TLS session via an application executed on said secure user device.

In one implementation, said secure communication interface performs further encryption and decryption of communications with a shared secret known to said secure user device and said interface.

In one implementation, the method consists of an additional step, prior to step A, which consists of transferring said shared secret to said secure user device.

In one implementation, said step of transferring said shared secret to said secure user device comprises scanning an optically, magnetically or wireless readable code.

In one implementation, said public encryption key of said determined user and said private key of said determined user comply with the S/MIME standard and are defined by an S/MIME certificate.

In one implementation, said digital data comprises a primary encryption key, and is further associated with primary data encrypted with said primary encryption data, said method comprising a subsequent step of decrypting said primary encryption data with said primary encryption key.

In one implementation, said digital data is further associated with an encrypted copy of said primary encryption key, said encrypted copy of said primary encryption key being encrypted with an escrow password.

Furthermore, the invention improves the situation by offering a computer programme product comprising instructions which, when the programme is executed by a computer, cause the computer to implement the method of the preceding implementations.

In one implementation, before said step A, said secure communication interface sends said password to said secure user device via a secure channel.

In addition, the invention improves the situation by offering a system allowing secure access to digital data, with said digital data being encrypted with a given user's public encryption key, and the system comprising:
a destination unit configured to receive the digital data;
a server configured to store the public encryption key of the user and receive a request from said user to access said digital data;
a user device configured to store a password;
a secure communication interface configured to issue a request to the secure user device to release the password and obtain said password from said user device in response to a validated security test issued by said user device to a user, wherein the server is configured to retrieve an encrypted private key of said user, said encrypted private key of said user being encrypted with said password, and decrypt said user's private key encrypted with said password to obtain the private key of said user, and decrypt said encrypted digital data with said user's private key, and present said digital data to said user.

In addition, the invention improves the situation by offering a system allowing secure access to digital data, with said digital data being encrypted with a given user's public encryption key, and the system comprising:
a server configured to store the user's public encryption key; and
a secured user device configured to receive via secure communication interface a request to release a password stored on said user device, said request being sent in response to receiving at said server a request from said user to access said digital data, send a security test to a user thereof, and in response to the validated security test, to release said password to said secure communication interface for retrieval by said server, said password being used in the decryption of an encrypted private key to obtain the private key of said user, and the decryption of said digital data encrypted with said user's private key, for the presentation of said digital data to said user.

It is further proposed to provide a method for secure access to digital data enabling simple configuration and use, as well as simple integration with non-compliant systems.

The above referenced system may include an enrollment path for the secure user device. In this enrollment path, the secure user device creates or imports the user's private key, encrypts the private key using a password controlled by/generated by the device, and uploads the public key and encrypted private key to the server.

In an additional embodiment of the present invention, a sender may target a recipient that is not yet enrolled in the system. This new external user may not have generated encryption keys in the system. In this embodiment, the system will generate temporary public and private keys to encrypt the data, store the data as pending and send an invitation for the external user to enroll/create an account. The external user will follow the enrollment path for the secure user device to create and store the public key and encrypted private keys. The newly stored public key is used to re-encrypt the data and the data is marked as ready. The data is accessed using the same method as previously described.

If the user of the system is a new external user, the method of secure access to digital data includes the following steps:
A. Receiving, at a server, a request from a first user to send secure digital data to a second user;
B. detecting, by the server, that the second user is an external user;
C. generating, by the server, a temporary public encryption key and a temporary private encryption key for the second user;
D. sending, by the server, the temporary public encryption key to the first user via a first user device;
E. encrypting, by the first user device, the digital data with the temporary public encryption key;
F. sending, by the first user device, the encrypted digital data to the server for storage;
G. sending, by the server, a message to the second user via a second user device that the secure digital data is pending;
H. generating, by the second user device, a validated security test, a password, a public encryption key and a private encryption key;
I. encrypting, by the second user device, the private encryption key with the password;
J. sending, by the second user device via a secure communication interface to the server, the public encryption key and the encrypted private key;
K. decrypting, by the server, the secure digital data using the temporary private encryption key;
L. encrypting, by the server, the secure digital data using the public encryption key;
M. sending, by the server via the secure communication interface, a request to the user device to release the password stored on the second user device;
N. obtaining the password via the secure communication interface, from the user device in response to the validated security test issued by the second user device to the second user; and
O. retrieving, via the server, the second user's encrypted private encryption key, the second user's private encryption key being encrypted with the password, decrypting the second user's encrypted private encryption key with the password to obtain the second user's private encryption key, decrypting the secure digital data using the private encryption key and presenting the secure digital data to the second user.

### BRIEF DESCRIPTION OF THE DRAWINGS

Other characteristics, details and advantages of the invention will become apparent on reading the description given with reference to the appended drawings given by way of example and which represent, respectively:

FIG. 1 is a schematic representation of an example of a system allowing secure access to digital data;

FIG. 2 shows an example of a method for secure access to digital data;

FIG. 3 shows an example of a method for secure access to digital data

FIG. 4 is a schematic representation of a second embodiment of a system allowing secure access to digital data;

FIG. 5 is a flow chart showing the steps of the method for secure access to digital data providing access for external users;

FIG. 6 is a flow chart showing the steps of the method for secure access to digital data indicating how an external user enrolls and enables access;

FIG. 7 is a flow chart showing the steps of the method for secure access to digital data indicating how an external recipient can decrypt data using the method.

### DETAILED DESCRIPTION

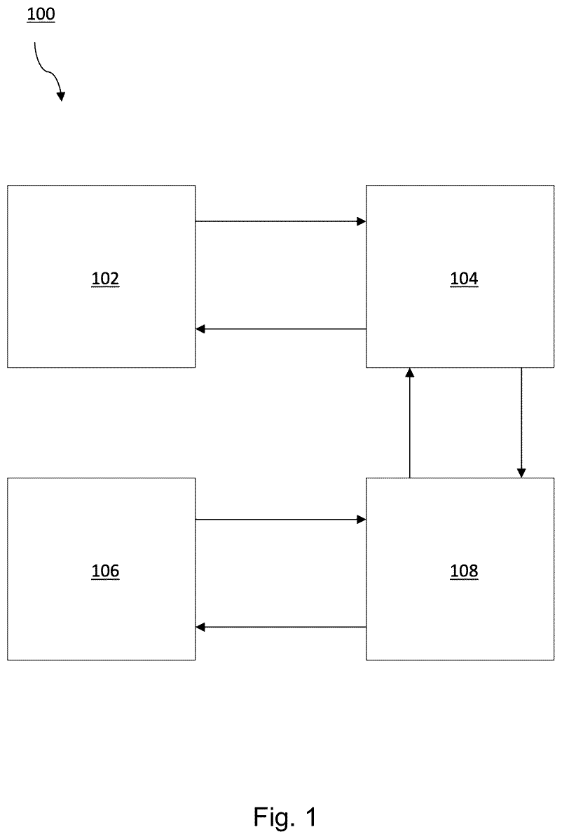

FIG. 1 illustrates an example of system 100 allowing secure access to digital data. Digital data is encrypted with a user's public encryption key. The digital data may, for example, be emails. The user's public encryption key may, for example, comply with the S/MIME standard and be defined by an S/MIME certificate. The system 100 comprises a destination unit 102, a server 104, a secure communication interface 108 and a user device 106.

The destination unit 102 may, for example, be a computer of a user making it possible to access one or more electronic mailboxes. A computer includes desktops and laptops, smart phones, tablets and even smart watches. Alternatively, the destination unit 102 may be an application on a user's computer, tablet or telephone, such as a smart phone, making it possible to access one or more mailboxes. For example, a first user may receive one or more emails from a second user that are encrypted with the first user's public key.

The server 104 may be, for example, a computer or a group of computing devices. For example, the server may be a host computer, a group of computers, or a group of servers operating as a unit. In one example, the server 104 may be a database server coupled to a web server. The server 104 may be coupled to a database and may include any hardware, software, other logic or combination of the foregoing to respond to requests from one or more computers. The server 104 may use a variety of computer structures, layouts, and compilations to respond to requests from one or more user computers.

The user's public encryption key is stored on the server 104. Thus, in order to access his digital data, the user sends a request to the server 104. For example, when the first user receives one or more emails from the second user that are encrypted with the first user's public key, the first user sends a request to the server 104 in order to access his emails. In addition, or alternatively, receipt of the request by the server 104 may constitute logging in.

The secure user device 106 may be a mobile device, for example a smart phone, a laptop, a tablet, or a smart watch. In another example, the secure user device 106 and the destination unit 102 may be the same apparatus comprising an application for accessing a mailbox and an application for storing and releasing a password. The password is randomly generated from the user device 106. Thus, by being randomly generated, this means that it cannot be guessed with knowledge about the user (unlike passwords usually including a date of birth, the name of the person's dog, his favourite sports team, etc.).

The secure user device 106 making it possible to store and release a password makes it possible to access the secure communication interface 108. For example, the secure communication interface 108 may be a third-party server enabling a password to be transferred securely. In another example, the secure communication interface 108 implements an SSL/TLS session via an application executed on the secure user device 106 enabling a password to be transferred in a secure manner. When the secure user device 106 sends a request to the server 104, the server 104 sends a request to the secure communication interface 108 which in turn sends a request to the secure user device 106 to release a password stored on the secure user device 106. For example, the secure user device 106 may comprise a memory for storing the password. In another example, the password may be stored in a secure chip of the secure user device 106 which may be a cryptographic chip integrated into the motherboard of the secure user device 106. In one example, the secure communication interface 108 previously transmits the password to the secure user device 106 via a secure channel in order to be stored in the secure user device 106. For example, the secure communication interface 108 and the secure user device 106 can communicate by encrypting the password for each other using a session key.

A security test issued by the secure user device 106 is used to release the password. For example, the user device 106 may include a device for generating biometric data such as a fingerprint, facial recognition, iris scan, or voice analysis sensor. The secure user device 106 can ask the user to enter his biometric data, for example his fingerprint, by placing his finger on the biometric sensor using his mobile phone. In another example, the biometric data may be a facial recognition or a vital sign such as the user's pulse or breathing. The secure user device 106 verifies that the fingerprint corresponds to that of the user. For example, the secure user device 106 may store biometric data associated with one or more users in order to compare them with the biometric data generated during the security test. The test is validated when the secure user device 106 determines that the biometric input satisfies a predefined similarity criterion with respect to the biometric data associated with the user. For example, the similarity criterion may correspond to a similarity threshold between the biometric input and the biometric data associated with the user.

If the test is validated by the secure user device 106, the password is obtained via the secure communication interface 108, from the secure user device 106. The password is then transmitted to the server 104. The server 104 retrieves the user's private key, which is encrypted with the password. For example, the server 104 may include a memory for storing private keys corresponding to different users and encrypted with passwords stored in the secure user device 106. The server 104 can then decrypt the user's private key with the password. Once the key has been decrypted, the server 104 can decrypt the digital data and transmit it to the destination unit 102. The user can then access his digital data. For example, the user can access his emails. In one example, the user's encrypted private key may conform to the S/MIME standard and be defined by an S/MIME certificate.

In one example, the digital data consists of a primary encryption key, and is further associated with primary data encrypted with the primary encryption data. Primary encryption data may be decrypted with the primary encryption key. For example, the digital data may further be associated with an encrypted copy of the primary encryption key, the encrypted copy of the primary encryption key being encrypted with an escrow password. In particular, two different keys (e.g., the private primary key held in escrow and the user's private encryption key) can be used to decrypt the digital data. For example, digital data can be encrypted with the primary encryption key (which is itself separately encrypted with an escrow password) and with the user's private key. Thus, in one example, the private primary key that makes it possible to decrypt the digital data is stored in escrow and the user's private key is stored on the server 104.

In one example, the secure communication interface 108 further performs encryption and decryption of the communications with a shared secret known to the secure user device 106 and the secure communication interface 108. For example, the transmission of the password between the secure user device 106 via the communication interface 108 and the server 104 can be encrypted and decrypted by the shared secret. The shared secret may be, for example, a secret phrase, a password, a large number or a random sequence of bits. In one example, before receiving the request at a secure user device 106 via a secure communication interface 108 to release the password on the destination unit 102, the shared secret may be transferred to the secure user device 106. For example, the transfer of the shared secret to the secure user device 106 may comprise the scanning of an optical, magnetic or wireless-readable code. In another example, the secure communications interface 108 or the secure user device 106 may generate the shared secret and transfer it to the secure user device 106 or the secure communications interface 108, respectively. Moreover, the transfer of the shared secret to the secure user device 106 can be carried out by the server 104, which sends a request to the destination unit 102 to release the password which is then transmitted to the user device 106, via the secure communication interface 108.

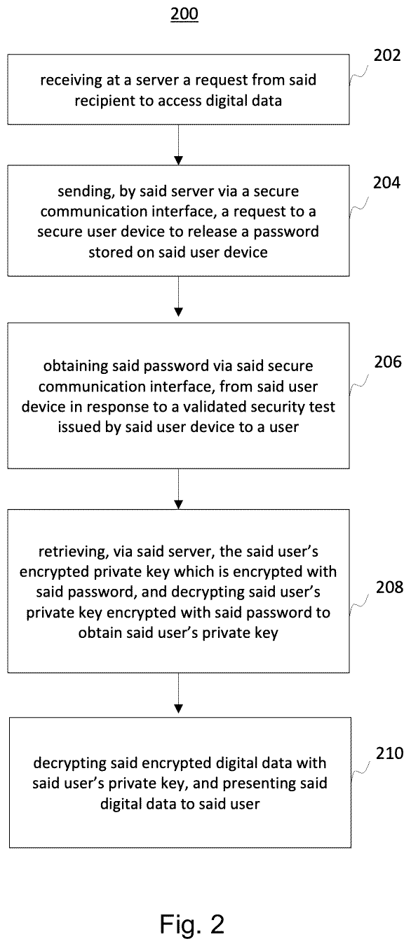

FIG. 2 illustrates a method 200 for secure access to digital data. The digital data is encrypted with a given user's public encryption key and stored on a server. For example, the method 200 may be implemented by the system 100 described above.

At block 202, method 200 comprises receiving at server 104 a request from the user to access the digital data. For example, a user can send a request from his computer or his mobile phone to the server 104 to access his emails which are encrypted with the public encryption key. In one example, the reception of the request constitutes a login session.

At the block 204, method 200 comprises sending a request by the server 104, via a secure communication interface 108, to a secure user device 106 to release a password stored on the user device 106. In one example, the password is stored in a secure chip of the secure user device 106. In one example, the secure communication interface 108 implements an SSL/TLS session via an application executed on the secure user device 106.

At block 206, method 200 comprises obtaining the password via the secure communication interface 108, from the user device 106, in response to a validated security test sent by the user device 106 to a user. For example, issuing the test may include comparing a biometric input with biometric data associated with the user stored on the secure user device 106, wherein the validated security test consists of determining that the biometric input meets a predefined similarity criterion with respect to the biometric data associated with the user. In one example, the test consists of comparing the user's fingerprint with a fingerprint associated with the user stored on the secure user device 106. In another example, the test may consist of a facial recognition or measurement of a vital sign (e.g., a pulse or breathing).

At block 208, the method consists of recovering, via the server 104, the user's encrypted private key which is encrypted with said the password, and decrypting the user's private key encrypted with the password to obtain the user's private key.

In block 210, the method comprises decrypting the digital data encrypted with the user's private key, and presenting the digital data to said user. For example, the user's emails can be decrypted with the user's decrypted private key and the user can access their emails.

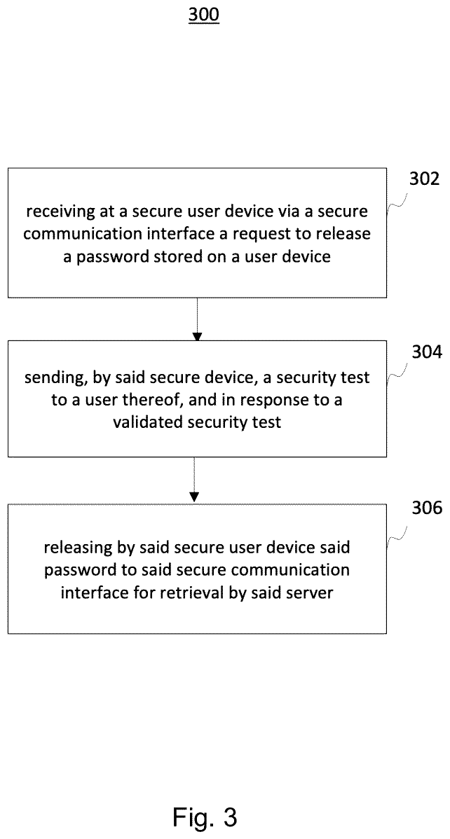

FIG. 3 illustrates a method 300 for secure access to digital data. The digital data is encrypted with a particular user's public encryption key and stored on a server. For example, method 300 may be implemented by the system 100 described above, and in particular, the destination unit 102, the server 104, the secure communication interface 108 and the user device 106 illustrated in FIG. 1.

At the block 302, method 300 consists of receiving a request at the secure user device 106, via the secure communication interface 108, to release a password stored on the secure user device 106. For example, the password is stored in a secure chip of the secure user device 106. The request is sent in response to receipt at the server 104 of a request from the user to access the digital data. In one example, the secure communication interface 108 implements an SSL/TLS session via an application executed on the secure user device 106.

At block 304, method 300 comprises transmitting, by the secure user device 108, a security test to a user thereof. For example, issuing the test may consist of comparing a biometric input with biometric data associated with the user stored on the secure user device 106, wherein the validated security test consists of determining that the biometric input meets a predefined similarity criterion with respect to the biometric data associated with the user. In one example, the test consists of comparing the user's fingerprint with reference biometric data associated with the user stored on the secure user device 106 (addition of facial control+measurement of the vital sign: pulse, respiration).

At block 306, method 300 comprises, in response to the validated security test, releasing the password by the secure user device 106 to the secure communication interface 108 for retrieval by the server 104, the password being used in the decryption of an encrypted private key to obtain the user's private key, and the decryption of the digital data encrypted with the user's private key, for presenting the digital data to the user.

In the examples of methods 200, 300 described above, the secure communication interface 108 can also perform an encryption and a decryption of the communications with a shared secret known to the secure user device 106 and to the interface 108. For example, before receiving a request at the secure user device 106, via the secure communication interface 108, to release the password stored on the user device 106, the shared secret may be transferred to the secure user device 106. Furthermore, the transfer of the shared secret to the secure user device 106 may comprise the scanning of an optical, magnetic or wireless-readable code.

In one example, before receiving at the server a request from the user to access the digital data, the secure communication interface 108 transmits the password to the secure user device 106 via a secure channel.

In addition, in the examples of methods 200, 300 described above, the public encryption key of the given user and the private key of the given user may be, for example, compliant with the S/MIME standard and defined by an S/MIME certificate.

Furthermore, in the examples of methods 200, 300 described above, the digital data may consist of a primary encryption key, and may also be associated with primary data encrypted with the primary encryption data, the method 200, 300 consisting of a subsequent step of decrypting the primary encryption data with the primary encryption key. In addition, the digital data is further associated with an encrypted copy of the primary encryption key, the encrypted copy of the primary encryption key being encrypted with an escrow password.

It should be understood that the implementations of the present invention may be implemented by a computer program product comprising instructions and being executed by a computer. For example, the methods 200, 300 may be implemented using computing devices, software, and/or a combination thereof. For example, the computing devices may be implemented using processing circuitry such as, but not limited to, a processor, a central processing unit (CPU), a controller, an arithmetic and logic unit (ALU), a digital signal processor, a microcomputer, a field, a programmable gate array (FPGA), a system on a chip (SoC), a programmable logic unit, a microprocessor, or any other device capable of responding to and executing instructions in a defined manner. The software may include a computer programme, programme code, instructions, or a combination thereof, for independently or collectively instructing or configuring a hardware device to operate as desired. The computer programme and/or programme code may include programme or computer-readable instructions, software components, software modules, data files, data structures, and/or the like, which may be implemented by one or more hardware devices, such as one or more of the aforementioned hardware peripherals. When a hardware device is a computer processing device (e.g., CPU, controller, ALU, digital signal processor, microcomputer, microprocessor, etc.), the computer processing device may be configured to execute programme code by performing arithmetic, logic, and input/output operations, according to the programme code. The control unit 106 may also comprise one or more storage devices. The storage device(s) may be tangible or non-transitory computer readable storage media, such as random access memory (RAM), read-only memory (ROM), permanent mass storage device (such as disk drive), (e.g. NAND flash) and/or any other similar data storage mechanism capable of storing and recording data. The storage device(s) may be configured to store computer programmes, programme code, instructions, or a combination thereof, for one or more operating systems, and/or to implement the examples of implementations described herein. The computer programmes, programme code, instructions, or combination thereof may also be loaded from a separate computer-readable storage medium into the storage device(s) and/or one or more computer processing devices using a drive mechanism. Such a separate computer-readable storage medium may comprise a USB (Universal Serial Bus) stick, a memory stick, a Blu-ray/DVD/CD-ROM player, a memory card and/or other computer-readable storage media.

As illustrated above, the invention allows the use of a simple system allowing access to data in a highly secure manner. Furthermore, the invention does not require the use of a multi-factor authentication protocol. The method of securely accessing digital data allows for easy configuration and use, as well as easy integration with non-compliant systems. The system described above does not use user passwords, which eliminates the need for the user to remember a string of letters and numbers. Additionally, a simple eight-character user password takes a brute-force computer anywhere from two hours to 21 days to crack, depending on the complexity of the phrase. Rather, the above system uses a 2048-bit hash that would take 15 billion years to decrypt using today's fastest computers. Furthermore, the system described above can use a secure hardware component such as a cryptographic chip in order to protect, store and prevent any attempt to extract this hash without biometric verification of the user On the contrary, other systems store passwords and encryption keys on the server, which can be accessed by the systems' administration or data centre personnel.

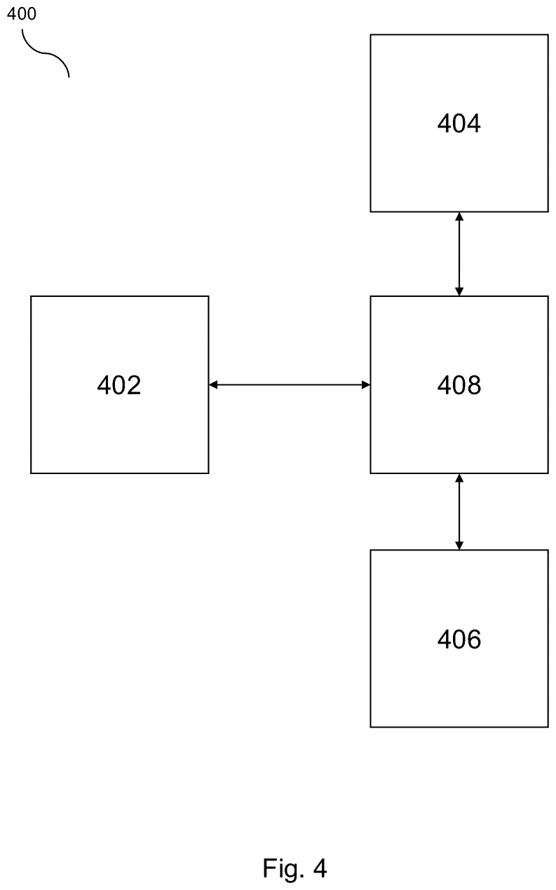

FIG. 4 illustrates a second embodiment of a system 400 allowing secure access to encrypted digital data by a third party who has not previously registered or enrolled in the system. In this embodiment, a first user attempts to send encrypted digital data through system to a second user who does not yet have encryption keys stored on system 400. In this example, digital data is encrypted with each user's public encryption key. The digital data may, for example, be emails. The user's public encryption key may, for example, comply with the S/MIME standard and be defined by an S/MIME certificate. The system 400 includes first user device 402, server 404, second user device 406 and secure communication interface 408.

First user device 402 may, for example, be a computer of a user making it possible to access one or more electronic mailboxes. A computer includes desktops and laptops, smart phones, tablets and even smart watches. First user device 402 may also be an application on a user's computer, tablet or telephone, such as a smart phone, making it possible to access one or more mailboxes. For example, a first user may receive one or more emails from a second user that are encrypted with the first user's public key.

Second user device 406 may also be a computer of a second user making it possible to access one or more electronic mailboxes, includes desktops, laptops, smart phones, tablets and smart watches. Second user device 406 may also be an application on a second user's computer, tablet or telephone, such as a smart phone, making it possible to access one or more mailboxes.

Server 404 may be, for example, a computer or a group of computing devices. For example, server 404 may be a host computer, a group of computers, or a group of servers operating as a unit. In one example, server 404 may be a database server coupled to a web server. Server 404 may be coupled to a database and may include any hardware, software, other logic or combination of the foregoing to respond to requests from one or more computers. Server 404 may use a variety of computer structures, layouts, and compilations to respond to requests from one or more user computers.

Secure communication interface 408 is any interface or channel that may transmit digital data in a secure manner that is generally inaccessible by unauthorized parties. Secure communication interface 408 may be a third-party server enabling a password to be transferred securely. In another example, secure communication interface 408 implements an SSL/TLS session via an application executed on first user device 402 or second user device 406 enabling a password to be transferred in a secure manner.

When a user of first user device 402 requests to send a secure message to a second user, the first user device 402 sends a request to server 404. Specifically, this request is for server 404 to access the encryption keys of the second user. If server 404 determines that the second user is an external user and does not have encryption keys stored on server 404, server 404 generates a set of a public and a private encryption key for the external user. The newly generated public encryption key is sent to first user device 402 where it is utilized to encrypt the secure message being sent by the first user. This encrypted secure message is then sent to server 400 via secure communication interface 308 and marked as pending for the external user.

Once the secure message is encrypted and stored as pending, server 404 sends second user an invitation to enroll in the system and create an account. The invitation to create an account is received on second user device 406. In this example, second user device 406 is a smartphone, but could also be a desktop computer, laptop computer, tablet computer or smart watch. In the preferred embodiment, second user device 406 includes biometric security features relying on any number of biometric characteristics to verify the second user's identity. Alternatively, second user device 406 may include any secure access method well known in the art, such as a user password, to verify the identity of the second user.

During the enrollment process, the second user device 406 will create a validated security test for the second user. The validated security test may include verification of a biometric characteristic of the second user such as fingerprint, facial recognition, iris scan, or voice analysis. The validated security test may also include entry of a specific password by the second user on second user device 406. Second user device 406 also generates a public and private encryption key for the second user. Lastly, second user device 406 generates a random password or hash for the second user. By being randomly generated, the password or hash cannot be guessed with knowledge about the user (unlike passwords usually including a date of birth, the name of the person's dog, his favourite sports team, etc.). Second user device 406 may comprise a memory for storing the password. In another example, the password may be stored in a secure chip of the second user device 406 which may be a cryptographic chip integrated into the motherboard of the second user device 406.

Once the second user device 406 creates the validated security test, encryption keys and password, second user device 406 encrypts the private encryption key with the password and transmits the public encryption key and encrypted private encryption key to server 404 via secure communication interface 408. Upon receipt of the public key, server 404 decrypts the secure message using the temporary private encryption key and re-encrypts the message using the new public key. The secure message is now ready for access by the second user via second user device 406. Server 404 then sends a request to second user device 406 to release the password stored on second user device 406 via secure communication interface 408.

The second user's encrypted private key may conform to the S/MIME standard and be defined by an S/MIME certificate.

Once the request for the password is received by second user device 406, secure user device 406 issues the previously generated security test to the second user. This security tests validates the second user's identity using biometric features or other password methods. The test is validated when the second user device 406 determines that the biometric input satisfies a predefined similarity criterion with respect to the biometric data associated with the second user. For example, the similarity criterion may correspond to a similarity threshold between the biometric input and the biometric data associated with the second user.

Once the security test is validated by second user device 406, the password is released to server 404 via secure communications interface 408.

Once the password is received by server 404, server 404 retrieves the second user's encrypted private key and decrypts the private key using the password. The secure message is then decrypted with the private key and presented to the second user via secure communications interface 408 and on second user device 406.

In some varieties of this embodiment, the secure communication interface 408 may perform encryption and decryption of the communications with a shared secret known to the second user device 406 and the secure communication interface 408. For example, the transmission of the password between the second user device 406 via the communication interface 408 and the server 404 can be encrypted and decrypted by the shared secret. The shared secret may be, for example, a secret phrase, a password, a large number or a random sequence of bits. In one example, before receiving the request at second user device 406 via a secure communication interface 408 to release the password, the shared secret may be transferred to the second user device 406. For example, the transfer of the shared secret to the second user device 406 may comprise the scanning of an optical, magnetic or wireless-readable code. In another example, the secure communications interface 408 or the second user device 406 may generate the shared secret and transfer it to the second user device 406 or the secure communications interface 408, respectively. Moreover, the transfer of the shared secret to the second user device 406 can be carried out by the server 404, which sends a request to the second user device 406 to release the password which is then transmitted to server 404, via the secure communication interface 408.

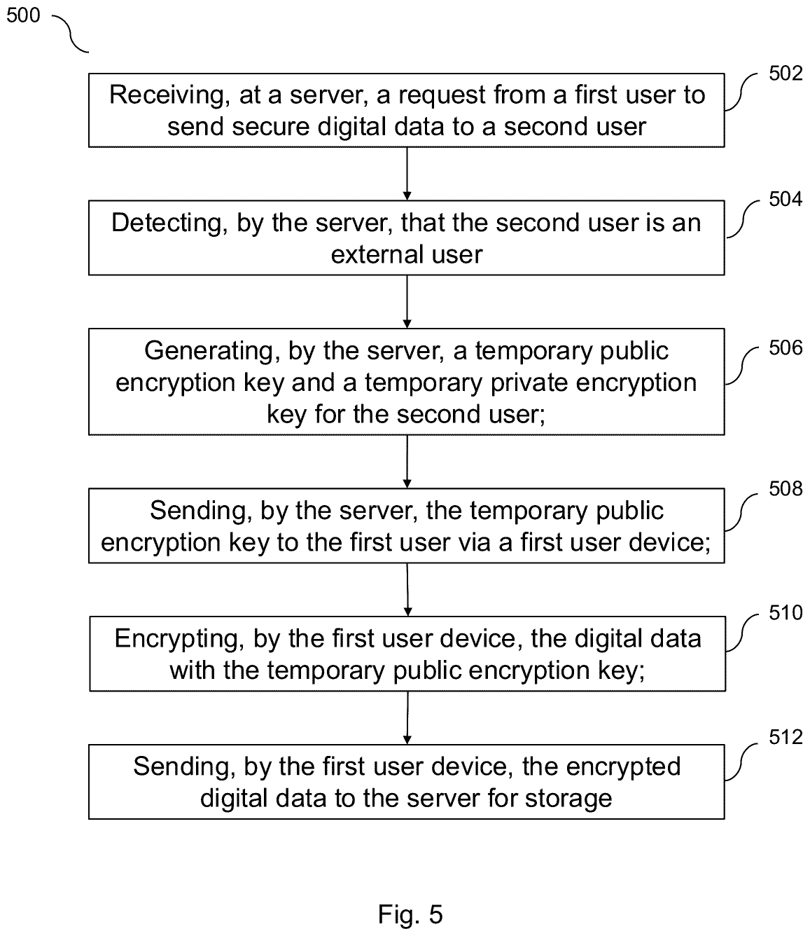

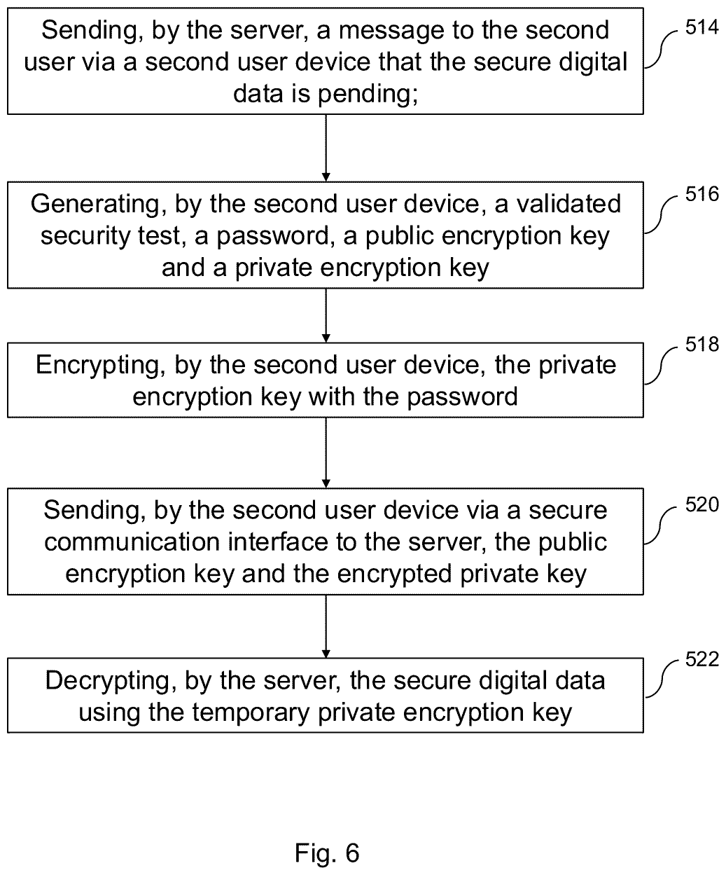

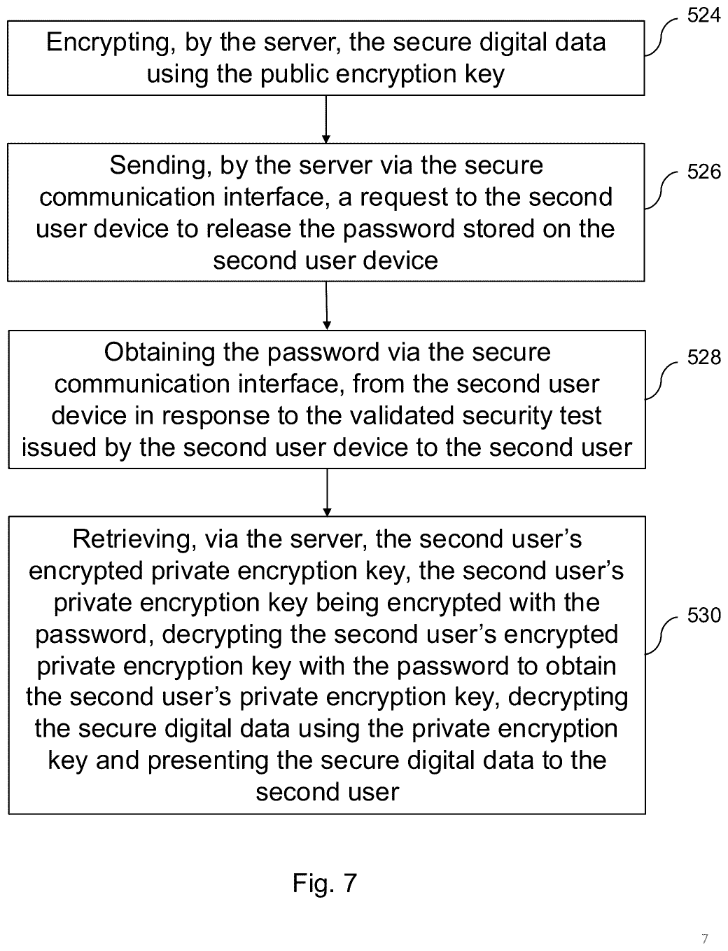

FIGS. 5-7 show the various steps of the method 500 of accessing secure data by a third party who is not enrolled in or registered for the system. At block 502, method 500 comprises receiving at a server a request from a first user to send a secure digital data to a second user. The first user may be accessing the system utilizing a first user device 402 which may be any computing device, including smartphones, tablets, desktop computers, laptop computers, smart watches or any other computing device well known the art. The secure digital data could be any digital data sent via a computing network such as email or other various computer data files. Server 404 may be, for example, a computer or a group of computing devices. For example, server 404 may be a host computer, a group of computers, or a group of servers operating as a unit. In one example, server 404 may be a database server coupled to a web server. Server 404 may be coupled to a database and may include any hardware, software, other logic or combination of the foregoing to respond to requests from one or more computers. Server 404 may use a variety of computer structures, layouts, and compilations to respond to requests from one or more user computers. The second user may be accessing the system 400 using a second user device 306, which may may be any computing device, including smartphones, tablets, desktop computers, laptop computers, smart watches or any other computing device well known the art.

Block 504 of method 500 comprises detecting, by the server 404, that the second user is an external user. In this step, server 404 determines whether there are encryption keys stored on server 404 for the second user. If there are no stored encryption keys, the user is considered an external user for whom encryption keys must be generated.

Block 506 of method 500 comprises generating, by the server, a temporary public encryption key and a private encryption key for the second user. This step generates temporary encryption keys that allow the digital data to be encrypted temporarily while the external user enrolls in the system. The digital data will be encrypted with the temporary public encryption key.

Block 508 of method 500 comprises sending, by the server, the temporary public encryption key to the first user via a first user device. In this step, the newly public encryption key is send to the first user via the first user device where it will be used to encrypt the digital data.

Block 510 of method 500 comprises encrypting, by the first user device, the digital data with the temporary public encryption key. In this step, the first user device encrypts the digital data with the temporary public encryption key.

Block 512 of method 500 comprises sending, by the first user device, the encrypted digital data to the server for storage. Here the digital data encrypted with the temporary public encryption key is sent to the server for storage.

Block 514 of method 500 comprises sending, by the server, a message to the second user via a second user device that the secure digital data is pending. This message tells the second user that they have secure digital data pending and includes an invitation to enroll/register for the system.

Block 516 of method 500 comprises generating, by the second user device, a validated security test, a password, a public encryption key and a private encryption key. In this step, the second user device 306 generates a validated security test, preferably utilizing verification of a biometric characteristic of the second user such as fingerprint, facial recognition, iris scan, or voice analysis. The validated security test may also include entry of a specific password by the second user on second user device 406. A password is generated randomly by second user device 306, and both a public and private encryption key are also generated.

Block 518 of method 500 comprises encrypting, by the second user device, the private encryption key with the password. The random password generated by the second user device 406 is used to encrypt the private encryption key also generated in block 516 of method 500.

Block 520 of method 500 comprises sending, by the second user device via a secure communication interface to the server, the public encryption key and the encrypted private encryption key. In this step, second user device 406 sends the previously generated and now encrypted private encryption key and public encryption key to server 404 via secure communications interface 408.

Block 522 of method 500 comprises decrypting, by the server, the secure digital data using the temporary private encryption key. Now that the second user has generated system encryption keys that can be accessed securely, the secure digital data, encrypted with the temporary encryption key, may be decrypted in preparation for being encrypted with the second user's encryption keys.

Block 524 of method 500 comprises encrypting, by the server, the secure digital data using the public encryption key. Server 404 may now encrypt the secure digital data with the second user's public encryption key for storage on the server.

Block 526 of method 500 comprises sending, by the server via the secure communication interface, a request to the second user device to release the password stored on the second user device. In this step, server 404 sends a request to second user device 306 to release the password stored on second user device 406. The second user's private encryption key is encrypted with the password and access to the password is required for access to the encrypted secure digital data.

Block 528 of method 500 comprises obtaining the password via the secure communication interface, from the second user device in response to the validated security test issued by the second user device to the second user. In response to the request to release the password, second user device 406 issues the stored security test to second user. This security test validates the second user's identity using biometric features such as fingerprint, facial recognition, iris scan, or voice analysis. The validated security test may also include entry of a specific password by the second user on second user device 406. Once the test is validated by matching of the stored biometric feature or password to the value input by the second user, the password is released to the secure communication interface 408.

Block 530 of method 500 comprises retrieving, via the server, the second user's encrypted private encryption key, the second user's private encryption key being encrypted with the password, and decrypting the second user's encrypted private encryption key with the password to obtain the second user's private encryption key, decrypting the secure digital data using the private encryption key and presenting the secure digital data to the second user. In this step, the password is retrieved from the secure communications interface 408 by server 404. The received password is then used to decrypt the second user's encrypted private encryption key, previously encrypted with the password. Now that the second user's private encryption key is decrypted, it is available to decrypt the secure digital data and present that digital data to the second user. The decrypted secure digital data may be transmitted to the second user device 406 by secure communications interface 408.

Steps 502-530 of method 500 comprise the entire method of accessing secure data by a third party who is not enrolled in or registered for the system. Steps 508, 510, 512, 514, 516, 518, and 520 may be performed separately as a method for enrolling a user in a secure system.

In this second embodiment, server 404 may be an email server, web server, data server or any other server type well known in the art. The password may also be a hash or any other password format well known in the art.

Although the invention has been illustrated and described in detail with the aid of preferred implementations, the invention is not limited to the examples disclosed. Other variants can be deduced by those skilled in the art without departing from the scope of protection of the claimed invention.

1. A method for secure access to digital data between two or more users comprising the following steps:
A. receiving, at a server, a request from a first user to send secure digital data to a second user;
B. detecting, by the server, that the second user is an external user,
C. generating, by the server, a temporary public encryption key and a temporary private encryption key for the second user;
D. sending, by the server, the temporary public encryption key to the first user via a first user device;
E. encrypting, by the first user device, the digital data with the temporary public encryption key;
F. sending, by the first user device, the encrypted digital data to the server for storage;
G. sending, by the server, a message to the second user via a second user device that the secure digital data is pending;
H. generating, by the second user device, a validated security test, a password, a public encryption key and a private encryption key;
I. encrypting, by the second user device, the private encryption key with the password;
J. sending, by the second user device via a secure communication interface to the server, the public encryption key and the encrypted private key;
K. decrypting, by the server, the secure digital data using the temporary private encryption key;
L. encrypting, by the server, the secure digital data using the public encryption key;
M. sending, by the server via the secure communication interface, a request to the second user device to release the password stored on the second user device;
N. obtaining the password via the secure communication interface, from the second user device in response to the validated security test issued by the second user device to the second user; and
O. retrieving, via the server, the second user's encrypted private encryption key, the second user's private encryption key being encrypted with the password, decrypting the second user's encrypted private encryption key with the password to obtain the second user's private encryption key, decrypting the secure digital data using the private encryption key and presenting the secure digital data to the second user.

2. The method of claim 1 where the validated security test is verification of a biometric characteristic of the second user.

3. The method of claim 2 where the biometric characteristic is selected from the group consisting of fingerprint, facial recognition, iris scan, or voice analysis.

4. The method of claim 1 where the password is stored in a secure chip of the second user device.

5. The method of claim 1 where the secure communication interface implements an SSL/TLS session via an application running on the second user device.

6. The method of claim 1 where the secure communication interface further performs encryption and decryption of communications with a shared secret known to said the second user device and the secure communications interface.

7. The method of claim 1 where the public encryption key of the second user and the private key of the second user conform to the S/MIME standard and are defined by an S/MIME certificate.

8. A computer program product embodied on a non-transitory computer readable storage medium consisting of instructions which, when the program is executed by a computer, cause the computer to implement the method of claim 1.

9. A system for secure access to digital data shared between two or more users comprising:
a server configured to receive a request to send or receive digital data, detect if a user is an external user, generate a temporary public encryption key and a temporary private encryption key for the external user, store the digital data, send a message to the external user that the digital data is pending, decrypting the digital data using the temporary private encryption key, storing a public encryption key and an encrypted private encryption key for the external user, encrypting the external user's data with the public encryption key, retrieving the external users encrypted private encryption key, the encrypted private encryption key being encrypted with a password, decrypting the external user's encrypted private encryption key with the password to obtain the external user's private encryption key, decrypting the digital data using the private encryption key and presenting the secure message to the external user;
a first user device for sending and receiving the digital data, encrypting the digital data with the temporary public encryption key, and sending the encrypted digital data to the server for storage; and
a second user device for sending and receiving the digital data, configured to generate and store a password, generate the public encryption key and the private encryption key, generate a validated security test, encrypt the private encryption key with the password, send the public encryption key and encrypted private encryption key to the server via a secure communications interface, and send the password in response to a request to release the password via the secure communications interface in response to a validated security test.

10. The system of claim 9 where the validated security test is verification of a biometric characteristic of the second user.

11. The system of claim 10 where the biometric characteristic is selected from the group consisting of fingerprint, facial recognition, iris scan, or voice analysis.

12. The system of claim 9 where the password is stored in a secure chip of the second user device.

13. The system of claim 9 where the secure communication interface implements an SSL/TLS session via an application running on the second user device.

14. The system of claim 9 where the secure communication interface further performs encryption and decryption of communications with a shared secret known to the second user device and the secure communications interface.

15. The system of claim 9 where the public encryption key of the second user and the private key of the second user conform to the S/MIME standard and are defined by an S/MIME certificate.
